(19) United States
(12) Patent Application Publication
(10) Pub. No.: US 2003/0025730 A1
(43) Pub. Date: Feb. 6, 2003

(54) Method for defining look and feel of a user interface obviating the requirement to write programming language code

(76) Inventor: Declan M. Brennan, Dublin (IE)

Correspondence Address: John Whelehan, 103-2609 Westview Drive, Unit 245, North Vancouver, BC, V7N 4N2, CA

(21) Appl. No.: 10/213,208

(22) Filed: Aug. 5, 2002

Related U.S. Application Data
(60) Provisional application No. 60/309,587, filed on Aug. 3, 2001.

(51) Int. Cl. G09G 5/00

(52) U.S. Cl. 345/760; 345/765; 345/762

(57) ABSTRACT

A method of automatically modifying the appearance properties 23 of a user interface element 20 when its state 22 changes without writing program code and automatically modifying a property 23 of a user interface element 20 in response to a change in a separate user interface element 20 without writing program code.

### CROSS REFERENCE TO RELATED ACTIONS

This application claims the benefit of PPA Ser. No. 60/309,587

### FEDERALLY SPONSORED RESEARCH

Not Applicable

### SEQUENCE LISTING OR PROGRAM

Not Applicable

### BACKGROUND OF THE INVENTION—FIELD OF THE INVENTION

The present invention pertains to the field of user interface design, for example the pages of web applications or screens in a traditional graphical user interface (‘GUI’) application. More particularly, the present invention relates to a method of defining the look and feel of such an application without the requirement to write programming code. Examples of programming code include JavaScript in a Hyper Text Markup Language (‘HTML’) page of a web application, and Visual Basic or Java code in a traditional GUI application.

### BACKGROUND OF THE INVENTION

It is common practice to allow drag and drop assembly of user screens (‘screens’) for computer applications. These screens may include forms in a traditional non web GUI application, web pages in a web application, computer aided design models in whole or part, a section of a 3 dimensional world in a modelling application such as a computer game or simulation or a process control diagram providing real time interactive control. However a drawback of current practice is the requirement to write code in a programming language to cause the appearance of a user interface element to change when its state changes, for example, when a button element is pressed. Another drawback of current practice is the requirement to write code in a programming language to cause the occurrence of a change in one element of the user interface to affect a property of another element in the user interface.

### SUMMARY OF THE INVENTION

According to the invention, there is provided a method which eliminates the requirement to write programming code to cause the appearance of a user interface element to change when its state changes and cause the occurrence of a change in one element of the interface to affect a property of another element in the user interface. The invention extends the degree of functionality that non-programmer users can achieve. For example, graphic designers may implement user interface effects including rollovers and latching buttons without the requirement to be skilled in the writing of programming code.

### BRIEF DESCRIPTION OF THE DRAWINGS

The present invention is illustrated by way of example and not limitation in the figures of the accompanying drawings, in which like references indicate similar elements and in which:

FIG. 1 shows an example of a web page button user interface element and some possible states.

FIG. 2 shows an example of how interface element event handlers should trigger actions to modify a state.

FIG. 3 shows an example of the states pertaining to a web application user interface and their definitions.

FIG. 4 shows an example of how a user interface requirement to “display an element with a green background when the mouse cursor is over it” could be described in XML.

FIG. 5 shows an example of the code that results when the description in FIG. 4 in converted into a cascading style sheet.

FIG. 6 shows an example of a cascading style sheet produced to manage states for two types of button.

FIG. 7 shows an example of an implementation of the invention for web applications to manage element states using the className property in the HTML Document Object Model.

FIG. 8 shows an example of a custom HTML tag that defines a calendar on a user interface web page.

FIG. 9 shows an example of a property editor element to set a month property.

FIG. 10 shows an example of the HTML code automatically generated by the action of dragging the property editor element from FIG. 9 off the property editor and dropping it onto the web form being edited.

FIG. 11 shows an example of the code resulting from dragging off three properties to control the orientation of a 3D model.

FIG. 12 depicts a modified version of the example shown in FIG. 10 where a radio group is used to specify the month being displayed by the calendar.

FIG. 13 shows the representation attributes and values of the example shown in FIG. 12.

FIG. 14 shows an overview diagram for the invention indicated both drag off properties from a property editor and state specific style properties in a stylesheet.

### DETAILED DESCRIPTION OF THE INVENTION

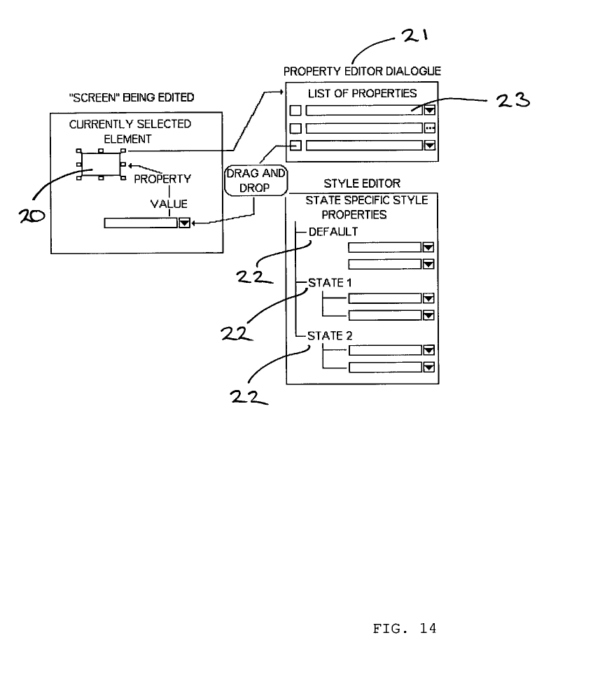

A method of causing the appearance of a user interface element to change when its state changes and causing the occurrence of a change in one element of the interface to affect a property of another element in the user interface is described. In the following description, for purposes of explanation, numerous specific details are set forth in order to provide a thorough understanding of the present invention. It will be evident, however, to one skilled in the art that the present invention may be practiced without these specific details. Refer to FIG. 14 for an outline of the invention.

State Specific Properties

A user interface element 20 (called a ‘UI Element 20’ in this specification) may have many appearance aspects, such as its colour, size or shape. A web page UI Element 20 for example, may have its appearance described by style properties 23 in a HTML page or separately in a Cascading Style Sheet. FIG. 1 depicts an example of some of the states that a web page button 2 UI Element 20 may have. The button 2 may exist in a plurality of states 3.

A preferred embodiment of the invention provides a system which automatically produces generic code for setting the states for each UI Element 20 as events occur. For example in a web application, an “OVER” state could indicate that the mouse cursor is currently over a given UI Element 20. To maintain this state, the system could automatically produce generic code producing the actions 4 for the event handlers 5 shown in FIG. 2.

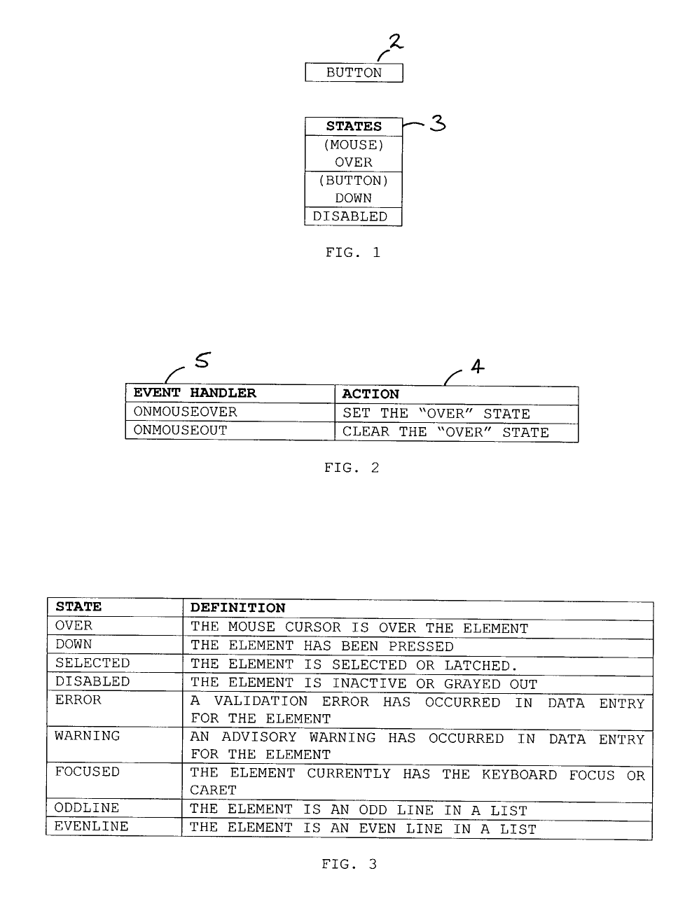

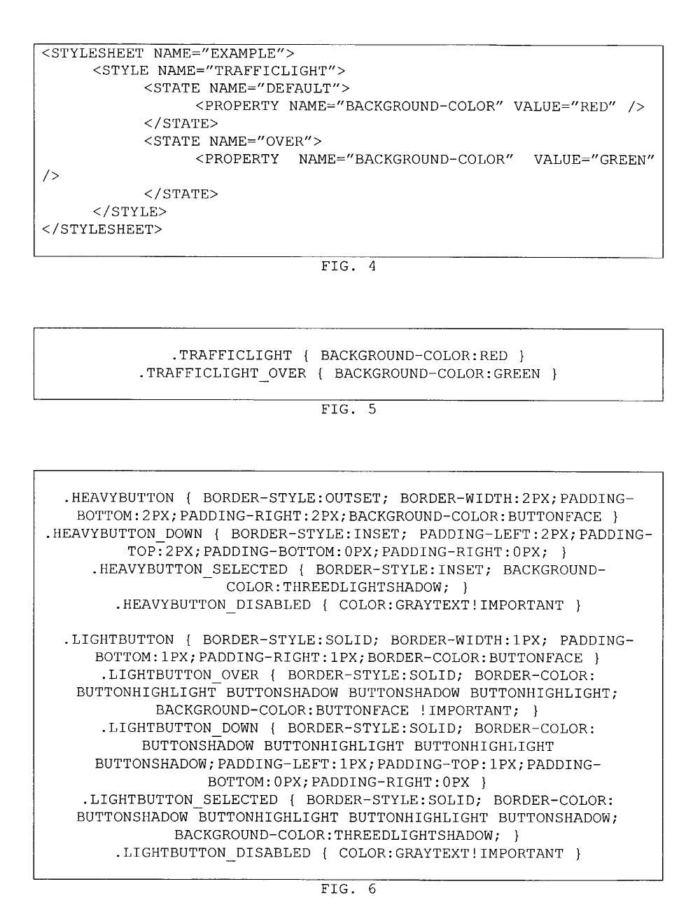

It is common for the UI Element 20 to be in several states simultaneously. Once the system has automatically produced the generic state setting, a user may then define appearance and behaviour for a UI Element 20 using a property editor 21 as shown in FIG. 14. The property editor 21 may allow the definition of style properties 23 for each state 22. Generally in such a property editor 21, both the states 22 and the style properties 23 would be sparse in that not all possible states 22 or style properties 23 would be defined for any given case. The property editor 21 may define the look and feel for a single UI Element 20. However a particular feature of the invention is the ability for the user to use the property editor 21 to create a style-sheet that could define a look and feel for a group of different UI Elements 20. FIG. 3 includes an example of the states 22 pertaining to a particular embodiment of the invention for a web application, and their definitions. In practice, the states 22 available will be dependant on the type of application being implemented.

The user may define additional states 22 along with a condition that must be true for the UI Element 20 to be in such a state 22. For example, it may be a requirement of a financial application to display negative numbers in the colour red. To achieve this, an additional user-defined state 22 may be created called for example: IsNegative, that has the condition: “is value less than zero?”

A possible embodiment of this invention for a web application includes a style-sheet editor that creates XML output similar to the listing in FIG. 4, which provides the means for a red UI Element 20 to turn green when the mouse is positioned over it. Typically an Extensible Stylesheet Transformation Language (XSLT) program would be used to convert this description to a Cascading Style Sheet (CSS). FIG. 5 shows an example of the code that results when the description in FIG. 4 in converted into a cascading style sheet.

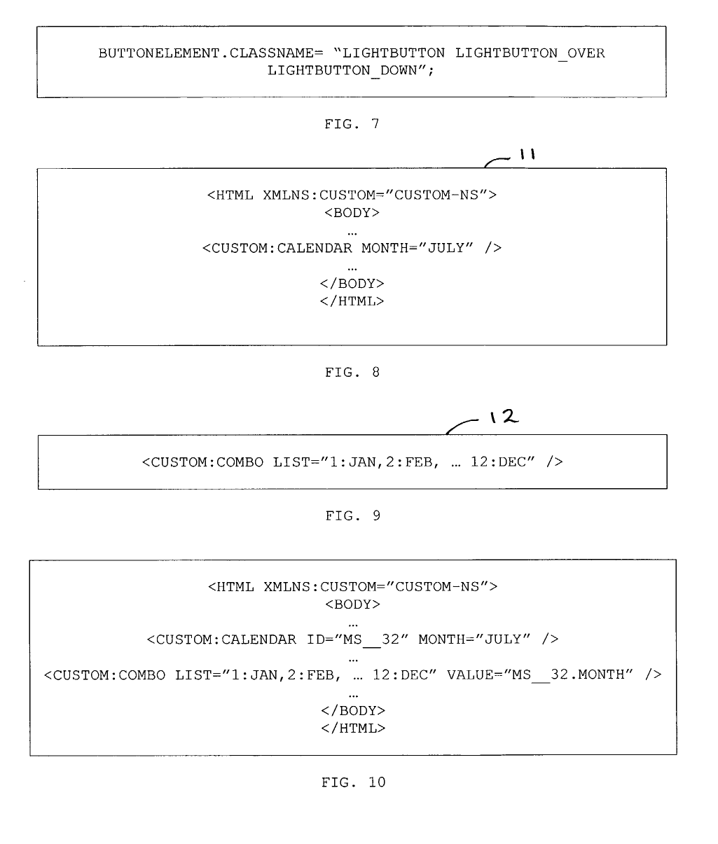

FIG. 6 shows a more elaborate example of a cascading style sheet produced to manage states 22 for two types of button UI Element 20. HEAVYBUTTON is defined to have a permanent border and LIGHTBUTTON is defined to have a border when the mouse is OVER it.

An implementation of this invention for web applications defines generic code to manage elements states 22 using the CLASS HTML attribute accessed through the className property in the HTML Document Object Model (‘HTML DOM’). A little known feature of this attribute (for the Microsoft Internet Explorer by Microsoft Corp. of Redmond Washington State, version 5.0 and higher) is that it can contain a list of styles. To define a state 22 for the LIGHTBUTTON where the mouse is Over it and it has been pressed Down, the system could generate the assignment 8 in FIG. 7.

Drag-off Properties

The invention further embodies a mechanism for creating an association between a property of one UT Element 20 and the value of another UT Element 20. For example, the property being modified could be the orientation-pitch of a 3D model element or the month being displayed by a calendar element. The value attached to this property may be modified for example by a slider element in the case of it having a continuous value or in another example, by a drop down list element or spin button element if it is a discrete value.

It is common in current practice to change the value of a UT Element's 20 property at design time by using another element that is part of a property editor 21 dialog. This invention describes a method whereby such property editor 21 elements may be dragged off and dropped on the screen being designed. The Drag and drop action is similar to the dragging and dropping of folders and files in the Windows Explorer program by Microsoft Corp. of Redmond Washington State. This action creates an association between the element whose property is being edited and the new property editor 21 element on the screen. This association persists beyond the design phase and is still in place when the screen is used by the user.

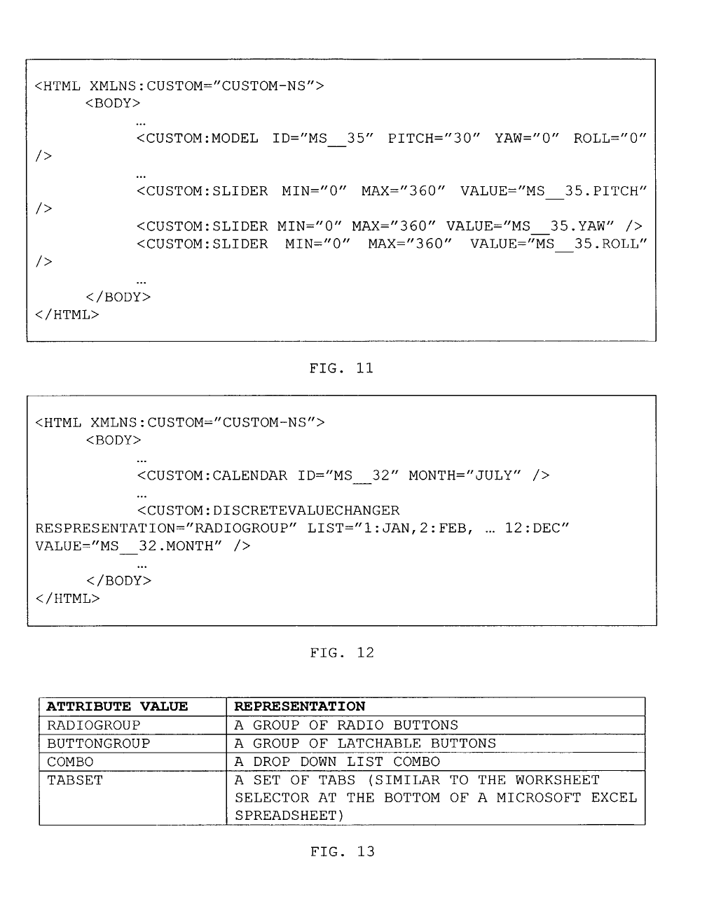

In one embodiment of the invention, a method for implementing a drag-off property's effect for a web application may be demonstrated using the following example. Consider a custom HTML tag 11 that defines a calendar in FIG. 8. When the property editor 21 is popped up at design time to change the month that the calendar is currently displaying, this is achieved through a property editor 21 element 12 in FIG. 9. The action of dragging the property editor 21 element off the property editor 21 and dropping it on the web form results in the system automatically generating the HTML code 13 in FIG. 10, which specifies an association between two HTML elements. This association is maintained by an id attribute which identifies the calendar element and the value attribute which specifies the property that the combo element is associated with.

A further example might result from dragging off three properties to control the orientation of a 3D model as depicted in FIG. 11.

A generalization of this method allows for generic value changer elements that may have several representations. A continuous value changer may appear as a slider or a text box with a spin button. A discrete value changer may appear in a number of ways including a drop down list, a radio group, a set of latching buttons or a set of tabs. The example outlined in FIG. 10 may be modified as shown in FIG. 12., with the representation attributes taking values including those shown in FIG. 13.

This representation could be defined at design time or if required, the property editor 21 could be dropped on the web form, setting up an association to allow it to be specified when the form is used.

In summary, it is clear that a benefit of the invention is that a user interface designer does not require knowledge of XML, XSLT, CSS, the HTML DOM or any scripting language to cause the appearance of the UI Element 20 to change when its state 22 changes and cause the occurrence of a change in one UI Element 20 to affect a property of another UI Element 20.

What is claimed is:

1. A method comprising:
automatically modifying the appearance properties of a user interface element when its state changes without writing program code, and
automatically modifying a property of a user interface element in response to a change in a separate user interface element without writing program code.

2. The method of claim 1 wherein said user interface is a web interface.
